(19) United States
(12) Patent Application Publication
(10) Pub. No.: US 2007/0116051 A1
(43) Pub. Date: May 24, 2007

(54) Method and apparatus for transporting IP datagrams over FLO network

(76) Inventor: An Mei Chen, San Diego, CA (US)

Correspondence Address: QUALCOMM INCORPORATED, 5775 MOREHOUSE DR., SAN DIEGO, CA, 92121, US

(21) Appl. No.: 11/398,201

(22) Filed: Apr. 4, 2006

Related U.S. Application Data
(60) Provisional application No. 60/739,875, filed on Nov. 23, 2005.

(51) Int. Cl. H04J 3/16; H04Q 7/24; H04J 3/24; H04J 3/22; H04Q 7/00

(52) U.S. Cl. 370/469; 370/328; 370/338; 370/474

(57) ABSTRACT

Systems and methodologies are described that facilitate transporting Internet protocol (IP) datagrams over a broadcast wireless network, such as a forward-link-only (FLO) network. According to aspects, third-party IP applications to operate over a FLO network without having to understand FLO-specific lower-layer protocols. In such cases, third party applications may request the FLO network as a data transmission pipe, and data may pass through FLO network without modification.

### CROSS-REFERENCE

This application claims the benefit of U.S. Provisional Application Ser. No. 60/739,875, entitled “METHODS AND APPARATUS FOR TRANSPORTING IP DATAGRAMS OVER WIRELESS NETWORKS,” filed on Nov. 23, 2005, the entirety of which is incorporated herein by reference.

### BACKGROUND

I. Field

The following description relates generally to wireless communications, and more particularly to facilitating permitting third-party IP applications to be operated over a forward-link-only (FLO) network in a wireless communication environment.

II. Background

Wireless communication systems have become a prevalent means by which a majority of people worldwide has come to communicate. Wireless communication devices have become smaller and more powerful in order to meet consumer needs and to improve portability and convenience. The increase in processing power in mobile devices such as cellular telephones has lead to an increase in demands on wireless network transmission systems. Such systems typically are not as easily updated as the cellular devices that communicate there over. As mobile device capabilities expand, it can be difficult to maintain an older wireless network system in a manner that facilitates fully exploiting new and improved wireless device capabilities.

A typical wireless communication network (e.g., employing frequency, time, and code division techniques) includes one or more base stations that provide a coverage area and one or more mobile (e.g., wireless) terminals that can transmit and receive data within the coverage area. A typical base station can simultaneously transmit multiple data streams for broadcast, multicast, and/or unicast services, wherein a data stream is a stream of data that can be of independent reception interest to a mobile terminal. A mobile terminal within the coverage area of that base station can be interested in receiving one, more than one or all the data streams carried by the composite stream. Likewise, a mobile terminal can transmit data to the base station or another mobile terminal. Such communication between base station and mobile terminal or between mobile terminals can be degraded due to channel variations and/or interference power variations.

Thus, there exists a need in the art for a system and/or methodology of improving throughput in such wireless network systems.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a method of transporting Internet protocol datacasts (IPDCs) over a forward-link-only (FLO) network in a wireless communication environment, may comprise setting up an IPDC flow, receiving the IPDC flow at a user device, and mapping a IP address and port data pair to a flow ID for the IPDC flow. The method may further comprise analyzing quality of service (QoS) parameter information, which may include at least one of average data rate, maximum burst size, peak rate, latency, start times, packet error rate, and duration and the identification of the originator or source of the IP datacast content. The method may still further comprise transmitting a request to activate a flow comprising a flow ID and start time, updating a flow description message in a control channel to include a newly activated flow ID, receiving a response that the flow has been activated, transmitting a response to acknowledge that the flow has been reserved, wherein the response comprises a flow handle that is employed to reference the reserved flow, receiving a broadcast datagram, and segmenting the datagram into FLO frames with appropriate headers.

According to another aspect, an apparatus that facilitates transmitting IP datagrams in a FLO network in a wireless communication environment may comprise a receiver that receives an IPDC flow, and a processor that maps an IP address and port data pair to a flow ID for the IPDC flow. The apparatus may further comprise a transmitter that transmits a request to activate a flow comprising a flow ID and start time. The processor may update a flow description message in a control channel to include a newly activated flow ID, and the receiver may receive a response that the flow has been activated. The transmitter may transmit an acknowledgment that the flow has been reserved, the acknowledgment comprising a flow handle that is employed to reference the reserved flow. The receiver may then receive a broadcast datagram and the processor may segment the datagram into FLO frames with appropriate headers.

According to yet another aspect, a wireless communication apparatus may comprise means for setting up an IPDC flow, means for receiving the IPDC flow, and means for mapping a IP address-and-port data pair to a flow ID for the IPDC flow. The apparatus may further comprise means for analyzing quality of service (QoS) parameter information, which in turn may comprise at least one of average data rate, maximum burst size, peak rate, latency, start times, packet error rate, and duration and the identification of the originator or source of the IP datacast content. Additionally, the apparatus may comprise means for requesting a FLO resource, means for transmitting a request to activate a flow, the request comprising a flow ID and start time, means for updating a flow description message in a control channel to include a newly activated flow ID, and means for segmenting a received datagram into FLO frames with appropriate headers.

Still another aspect relates to a computer-readable medium having a computer program comprising computer-executable instructions for generating an IPDC flow, receiving the IPDC flow at a user device, and mapping a IP address and port data pair to a flow ID for the IPDC flow. The instructions may further comprise analyzing quality of service (QoS) parameter information, wherein the QoS parameters comprise at least one of average data rate, maximum burst size, peak rate, latency, start times, packet error rate, and duration and the identification of the originator or source of the IP datacast content. The computer-readable may further store instructions for requesting a FLO resource, for transmitting a request to activate a flow comprising a flow ID and start time, for updating a flow description message in a control channel to include a newly activated flow ID, for receiving a response that the flow has been activated, and for transmitting a response to acknowledge that the flow has been reserved, wherein the response comprises a flow handle that is employed to reference the reserved flow, for receiving a broadcast datagram, and for segmenting the datagram into FLO frames.

A further aspect relates to a processor that executes instructions for increasing throughput in a wireless communication environment, the instructions comprising setting up an IPDC flow, receiving the IPDC flow at a user device, and mapping a IP address and port data pair to a flow ID for the IPDC flow. The processor may further execute instructions for requesting a FLO resource, transmitting a request to activate a flow comprising a flow ID and start time, updating a flow description message in a control channel to include a newly activated flow ID and receiving a response that the flow has been activated, transmitting a response to acknowledge that the flow has been reserved, wherein the response comprises a flow handle that is employed to reference the reserved flow, receiving a broadcast datagram, and for segmenting the datagram into FLO frames.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates a wireless network communication system in accordance with various aspects presented herein.

FIG. 2 is an illustration of a methodology for performing an Internet protocol datacast (IPDC) in a forward-link-only (FLO) network, in accordance with one or more aspects.

FIG. 3 is an illustration of a system that facilitates IP datacast over a FLO network, in accordance with one or more aspects.

FIG. 4 is an illustration of a system that facilitates supporting IP datacast in a FLO network, in accordance with one or more aspects described herein.

FIG. 5 illustrates an “AddFlow” interface that facilitates permitting an IP datacast source to request a FLO resource, in accordance with various aspects.

FIG. 6 is an illustration of an activate/deactivate flow interface that facilitates communication between an IP datacast source and a multiplexer (MUX), in accordance with various aspects.

FIG. 7 is an illustration of a system that facilitates transmission over a bearer path between an IP datacast source and an FSN, in accordance with one or more aspects.

FIG. 8 illustrates a protocol stack that facilitates providing an IP datacast service and for flow delivery, in accordance with various aspects.

FIGS. 9 and 10 illustrates a timeline for performing IP datacast service with an AddFlow protocol to a FLO device, and a timeline for performing IP datacast service without an AddFlow protocol, in accordance with various aspects herein

FIG. 11 illustrates a methodology of providing an IP datacast service to a FLO device, in accordance with various aspects.

FIG. 12 illustrates a timeline for receiving IP datacast content at a user device, in accordance with various aspects described herein.

FIG. 13 illustrates a methodology of receiving IP datacast content over a FLO interface at user device, in accordance with several aspects.

FIG. 14 illustrates an IPv4 multicast address format, in accordance with various aspects.

FIG. 15 is an illustration of an IPv6 multicast address format, in accordance with various aspects.

FIG. 16 illustrates a timeline for activating and transmitting an IP datacast flow, in accordance with various aspects

FIG. 17 is an illustration of a wireless network environment that can be employed in conjunction with the various systems and methods described herein.

FIG. 18 illustrates a communication network that comprises a transport system that operates to create and transport multimedia content flows across data networks, in accordance with various aspects.

FIG. 19 illustrates various aspects of a content provider server suitable for use in a content delivery system.

FIG. 20 illustrates a content server (CS) or device suitable for use in a content delivery system, in accordance with one or more aspects

FIG. 21 an illustration of an apparatus that facilitates performing IP datacasts over a FLO interface, in accordance with various aspects presented herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “system,” and the like are intended to refer to a computer-related entity, either hardware, software, software in execution, firmware, middle ware, microcode, and/or any combination thereof. For example, a component may be, but is not limited to being, a process running on a processor, a processor, an object, an executable, a thread of execution, a program, and/or a computer. One or more components may reside within a process and/or thread of execution and a component may be localized on one computer and/or distributed between two or more computers. Also, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal). Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

Furthermore, various embodiments are described herein in connection with a subscriber station. A subscriber station can also be called a system, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, various storage media described herein can represent one or more devices and/or other machine-readable media for storing information. The term machine-readable medium” can include, without being limited to, wireless channels and various other media capable of storing, containing, and/or carrying instruction(s) and/or data.

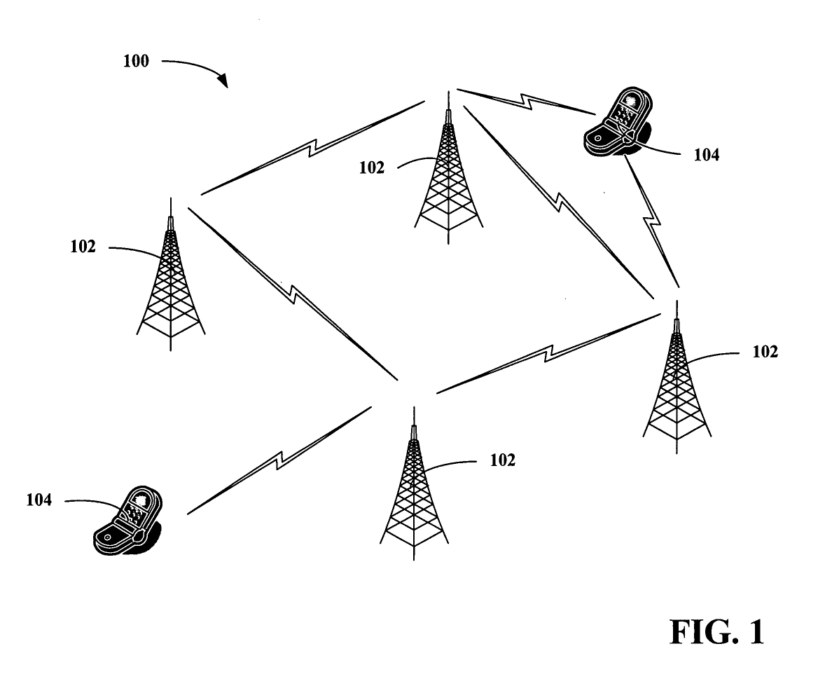

Referring now to FIG. 1, a wireless network communication system 100 is illustrated in accordance with various embodiments presented herein. System 100 can comprise one or more base stations 102 in one or more sectors that receive, transmit, repeat, etc., wireless communication signals to each other and/or to one or more mobile devices 104. Each base station 102 can comprise a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Mobile devices 104 can be, for example, cellular phones, smart phones, laptops, handheld communication devices, handheld computing devices, satellite radios, global positioning systems, PDAs, and/or any other suitable device for communicating over wireless network 100. System 100 can be employed in conjunction with various aspects described herein in order facilitate monitoring and/or switching between forward-link-only (FLO) channels in a wireless communication environment, as set forth with regard to subsequent figures.

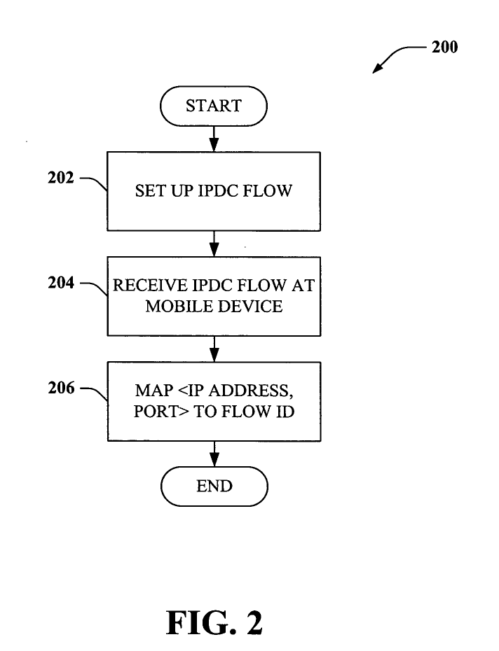

Referring to FIG. 2, a methodology relating to performing IP datacasts in a FLO network is illustrated. The methodologies described herein may be performed in an FDMA environment, an OFDMA environment, a CDMA environment, a WCDMA environment, a TDMA environment, an SDMA environment, or any other suitable wireless environment. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

FIG. 2 is an illustration of a methodology 200 for performing an Internet protocol datacast (IPDC) in a forward-link-only (FLO) network, in accordance with one or more aspects. At 202, an IPDC flow may be set up. Set up of the IPDC flow may comprise various acts, described in greater detail below. At 204, the IPDC flow may be received at a user device. The user device may map an IP address and port information to the flow ID in order to facilitate transporting IP datagrams over a broadcast wireless network, at 206. Method 200 thus allows any third-party IP applications to be operated over the FLO network without having to understand FLO-specific lower layer protocols. The IP datacast feature can provide a wireless IP multicast service that allows the FLO or third-party operator to multicast content using Internet Engineering Task Force (IETF) protocol over the FLO network. The FLO network can additionally provide a range of quality-of-service (QoS) benefits for delivering IP multicast datagrams.

For example, the IP datacast may be offered as a FLO service, or may be offered by a third-party service provider, and the FLO network may be used as a data pipe. In the first model, IP datacast may be purchased as a FLO subscription package, and subscription and key management may be handled through the FLO client application on the end user's mobile device. According to the second model, a third-party service provider may offer IP datacast services. The services need not be listed as FLO subscription packages, and subscription and key management may be performed externally to the FLO network. A third-party service provider would request the FLO network as a data transmission pipe and data payload would pass through the network without modification.

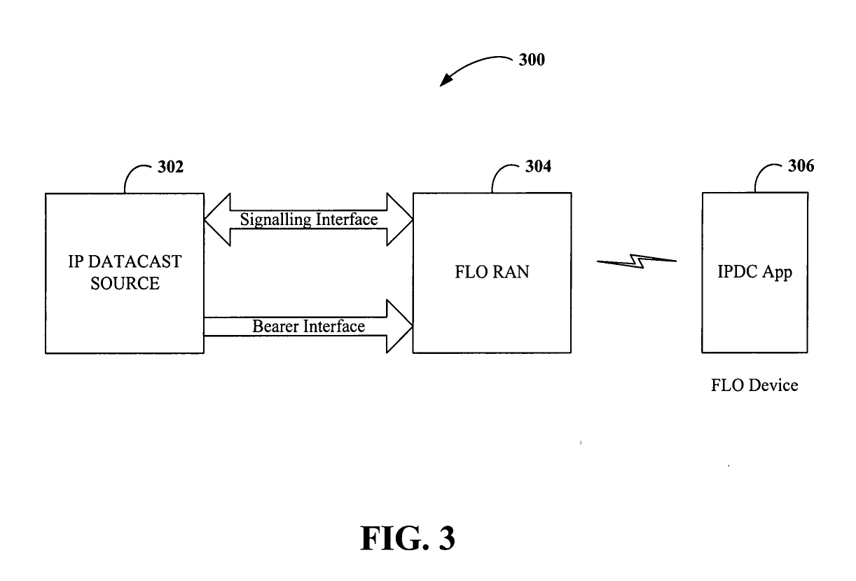

FIG. 3. is an illustration of a system 300 that facilitates IP datacast over a FLO network, in accordance with one or more aspects. System 300 comprises the following logical system components: an IP Datacast source 302, a FLO radio-access network (RAN) 304, and a FLO Device hosting an IP Datacast application 306. There are two mechanisms for which the IP Datacast can request FLO RAN resource. For instance, all the data may be provisioned and the signaling interface may be made optional. According to another aspect, both provisioning and/or a control interface may be required to request for FLO RAN resource. According to the latter aspect, certain information may be specified for the IP datacast source 302, such as one or more of IP multicast destination address, UDP port number, average data rate, maximum burst size, maximum latency, peak rate, start time(s), duration(s), source ID, whether encryption is enabled/disabled, whether header compression is enabled/disabled, etc. Each IP datacast may be defined as a pair consisting of an IP multicast address and a port number. The Quality of Service (QoS) parameters may include average data rate, maximum peak rate, maximum burst size, maximum latency, and packet error rate.

The QoS parameters may be employed by the FLO RAN 304 for admission control and scheduling. The IP Datacast may have one start time with an infinite duration. According to another aspect, the IP datacast service may be a scheduled data service, where the flow is on for a given time duration and is then off, then on again, and so forth. For this type of IP datacast flow, there can be one or more start times with associated durations. A source ID identifies the source of the flow and may be used to authenticate the IP datacast source 302. IP datacast source 302 may specify whether encryption may be applied to the IP datagrams of the IP datacast flow and whether header compression may be applied.

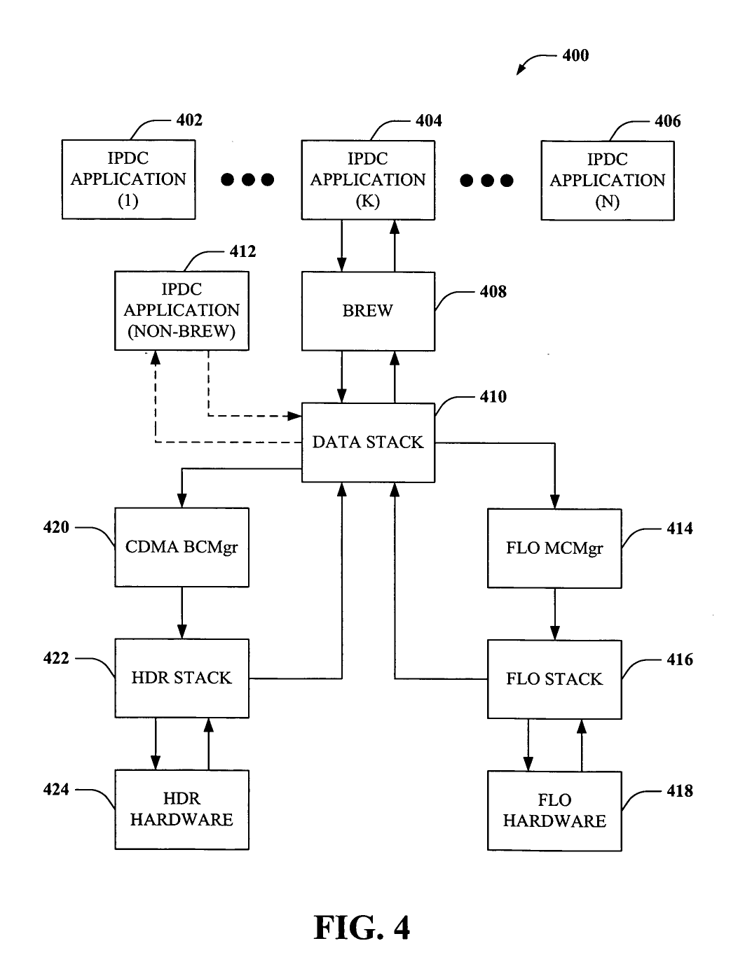

FIG. 4 is an illustration of a system 400 that facilitates supporting IP datacast in a FLO network, in accordance with one or more aspects described herein. An IP datacast (IPDC) application 402, 404, 406 may be associated with a binary run-time-embedded for wireless (BREW®)-based application 408, an Advanced Mobile Subscriber Software (AMSS)-native application 410, or some other suitable application. The IPDC application 402, 404, 406 may, whether a BREW application 408 or a non-BREW application 412, may perform DNS service discovery to resolve the service name with its <IP multicast address, port number> pair. Application 408 may be operatively associated with a data stack 410, which in turn may provide information to a CDMA broadcast manager 420. The CDMA Broadcast manager 420 may provide in formation to an HDR stack 422, which in turn is operatively associated with HDR hardware 424 that provides functionality to system 400 in parallel with various FLO components, described below.

A FLO Multicast Manager (FLOMCMgr) 414 is the logical function on the device that performs the mapping from the <IP multicast address, port number> pair to an IP datacast flow ID. During the IP datacast, the IP datacast application 404 may open a multicast socket with an IP multicast address and port number as specified by the <IP multicast address, port number> pair on a FLO air interface. The FLOMCMgr 414 receives a socket event request to open the FLO air interface according to the mapping of the IP datacast <IP multicast address, port number> pair to a flow ID. The FLOMCMgr 414 registers with a FLO stack 416 to be notified of IP Datacast flows when they become active. The FLO stack 416 receives Control Channel updates and notifies the FLOMCMgr 414 of a latest version Flow Description Message. The FLOMCMgr 414 requests the FLO Stack 416 to activate the IP Datacast flow. If the Flow Description Message indicates that the IP Datacast flow is active, FLO Hardware 418 tunes to the IP Datacast flow ID to receive the Physical Layer Packets (PLPs). The PLPs are then routed to the FLO Stack 416, where the IP packets are reconstructed and routed to the Data Stack 410.

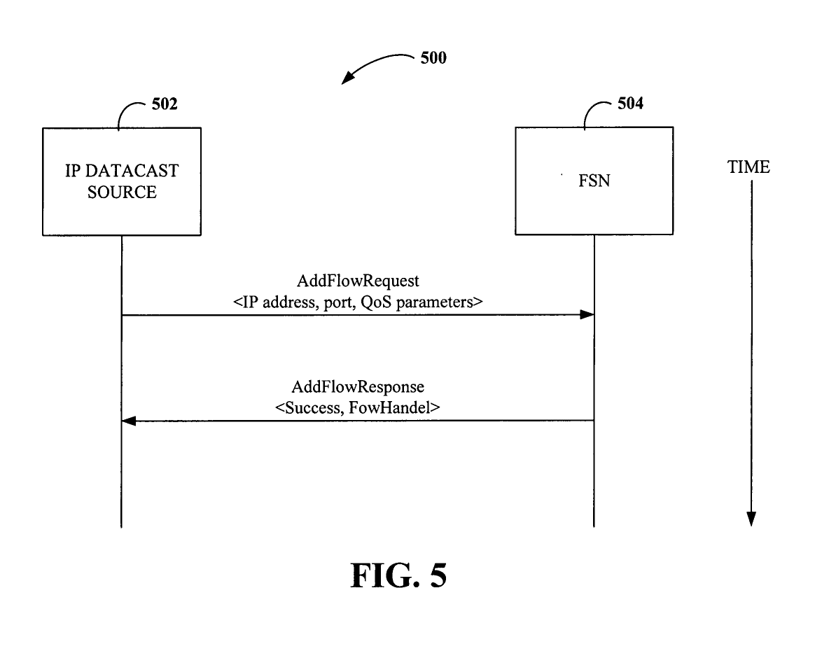

FIG. 5 illustrates an “AddFlow” interface 500 that facilitates permitting an IP datacast source to request a FLO resource, in accordance with various aspects. IP datacast source 502 requests a FLO resource by sending an AddFlowRequest message to an FSN 504, which includes information such as IP address, port number, and QoS parameters. FSN 504 performs admission control of the IP datacast source 502 based on its provisioned information. FSN 504 may then provide an AddFlowResponse that indicates a successful AddFlowRequest and information related to a flow handle that may be utilized by IP datacast source 502.

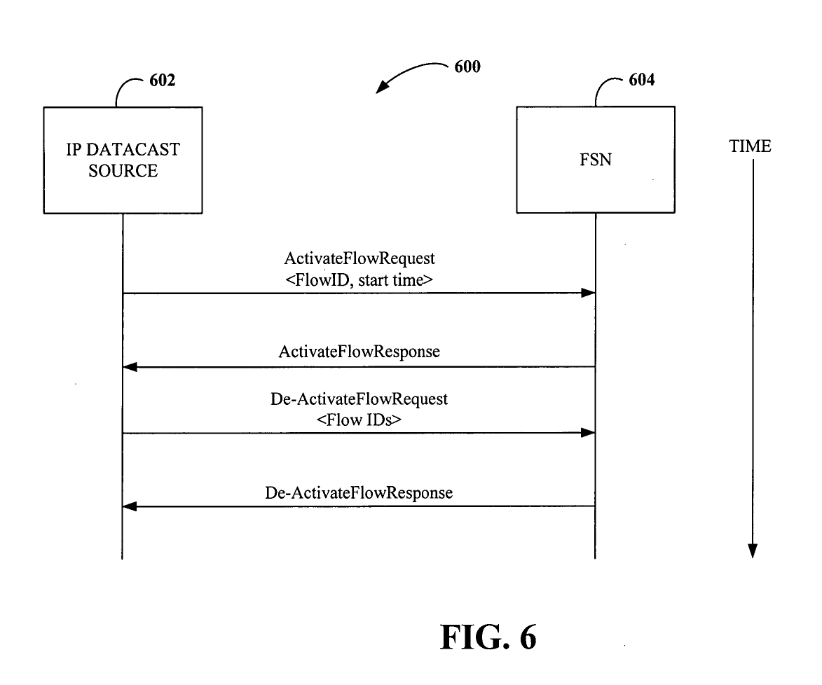

FIG. 6 is an illustration of an activate/deactivate flow interface 600 that facilitates communication between an IP datacast source and a multiplexer (MUX), in accordance with various aspects. An FSN 602 utilizes the activate/deactivate flow interface 600 to notify a MUX 604 that an IP datacast flow will be on or off the air, respectively. The FSN 602 sends an ActivateFlowRequest message to MUX 604 to specify the flow ID corresponding to the IP datacast flow that will be on air, as well as the start time of the content transmission of the flow. MUX 604 updates a flow description message and a system parameters message to reflect that a new flow ID has been added. FSN 602 uses a De-ActivateFlowRequest message that comprises one or more flow IDs for flows that are to be deactivated to remove one or more IP datacast flows. Once MUX 604 has successfully processed the message, it will remove the flow IDs from the flow description message and will update the system parameters message. No further content associated with the successfully removed flow ID need be broadcasted.

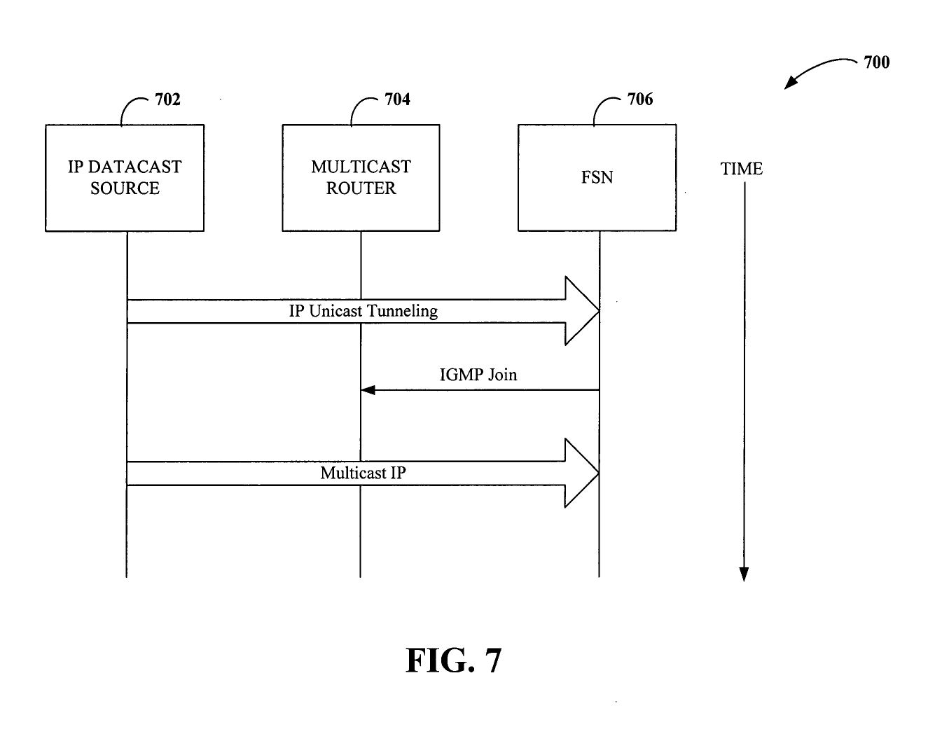

FIG. 7 is an illustration of a system 700 that facilitates transmission over a bearer path between an IP datacast source and an FSN, in accordance with one or more aspects. If multicast routing between IP datacast source 702 and FSN 706 is not enabled, IP datacast source 702 may utilize an IP unicast tunneling protocol when delivering a multicast IP datagram to FSN 706. Additionally or alternatively, if multicast routing between IP datacast source 702 and FSN 706 is enabled, FSN 706 may transmit an Internet Group Management Protocol (IGMP) Join request to a multicast router 704, to join with the specified multicast group and enter a first hop router. Multicast IP datagrams may then be routed to the FSN 706 using routing protocol. FSN 706 may support the accepting unicast IP tunneling of multicast IP datagrams in the event that multicasting routing between FSN 706 and IP datacast source 702 is not available.

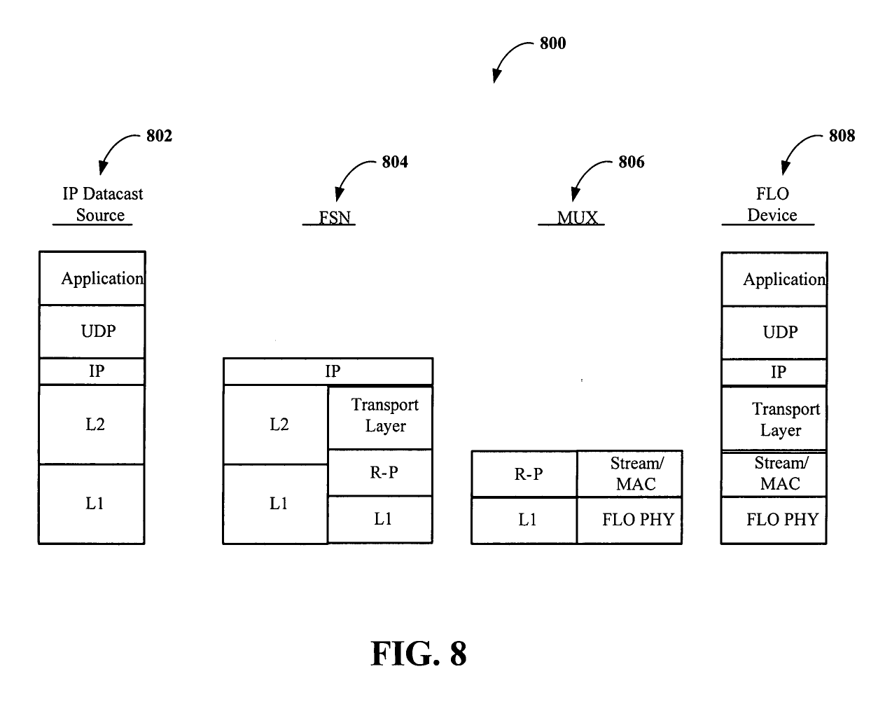

FIG. 8 illustrates a protocol stack 800 that facilitates providing an IP datacast service and for flow delivery, in accordance with various aspects. Although not described in detail herein, those of skill in the art will appreciate that Real-time Protocol (RTP) may be utilized between end-points of the stacks of FIG. 8 to synchronize the different IP datacast flows. Additionally or alternatively, the synchronization function may be performed by an IP datacast application on the device. An IP datacast stack 802 comprises a plurality of protocols, such as an application protocol, a UDP protocol, an IP protocol, a second-layer (L2) protocol, and a first-layer (L1) protocol, in descending order. An FSN protocol stack 804 may comprise and IP layer protocol as well as L2 and L1 protocols. In parallel with the L1 and L2 protocols, the FSN protocol stack 804 may comprise a transport layer protocol, an R-P protocol, and an additional L1 protocol underlying the R-P protocol. A MUX protocol stack 806 may comprise an R-P protocol overlying an L1 protocol, in parallel with a stream/middle access channel (MAC), which in turn overlies a FLO physical layer. Finally, a FLO device protocol stack 808 may comprise an application layer, a UDP layer, an IP layer, a transport layer, a stream/ MAC layer, and a FLO physical layer, in descending order.

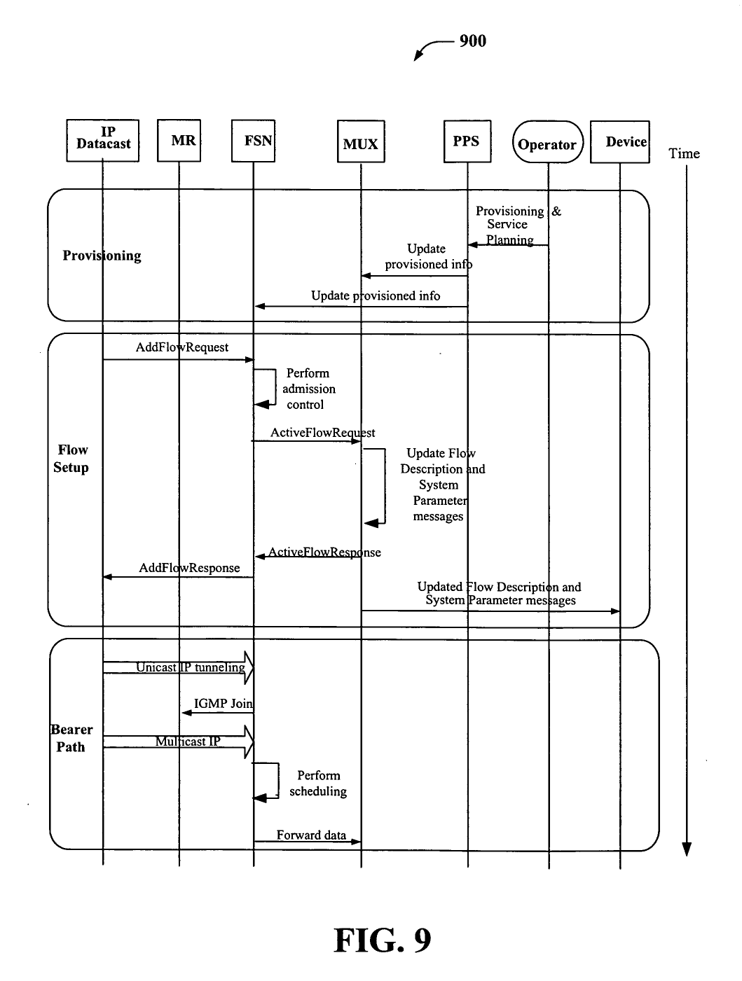

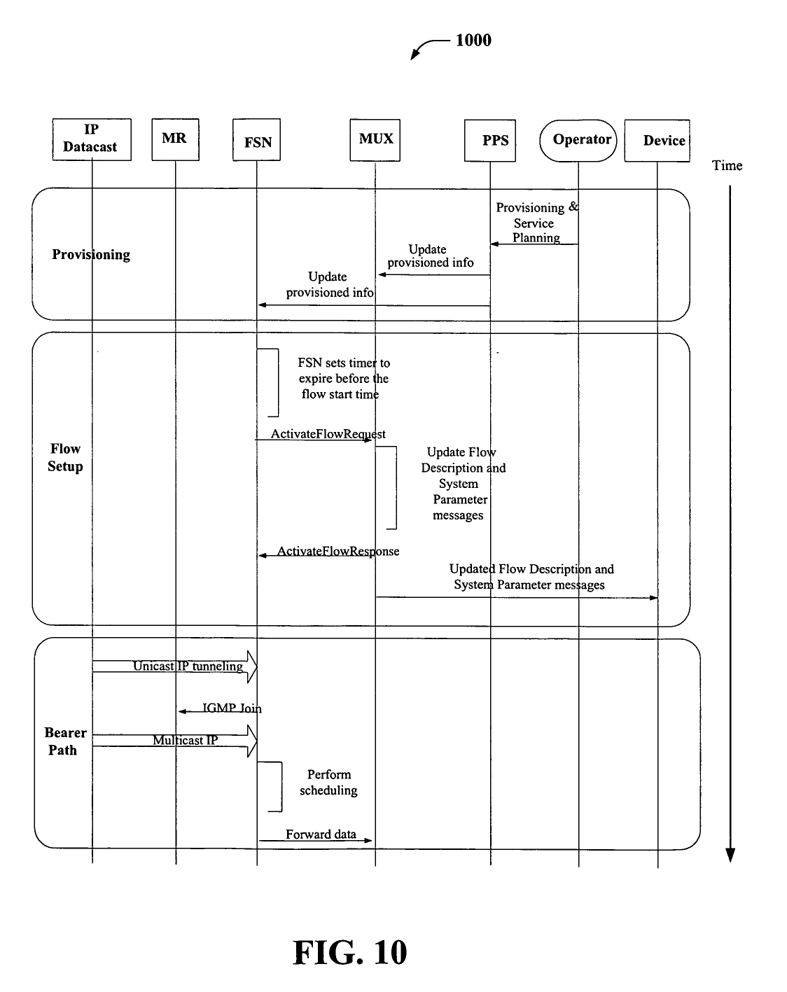

FIGS. 9 and 10 illustrates a timeline 900 for performing IP datacast service with an AddFlow protocol to a FLO device, and a timeline 1000 for performing IP datacast service without an AddFlow protocol, in accordance with various aspects herein. IP datacast comprises an IP datacast flow setup mechanism and reception of the IP datacast at a device. Flow setup relates to the operational concepts for setting up an IP datacast flow on the network side, and comprises determining what information may be provisioned to set up an IP datacast flow, how an IP datacast source signal may be transmitted to the FLO RAN to set up an IP datacast flow, how IP datacast content is to be transported to the FLO RAN, etc. The second part of IP datacast operation relates to the operational concepts behind the mobile device receiving the IP datacast content. On the network side, setting up an IP datacast flow may be logically grouped into a provisioning phase, a flow set up phase, and a bearer path setup phase. If an AddFlow interface is not supported, as illustrated in FIG. 10, an FSN may automatically send the message to a MUX to activate a flow based on provisioned information. Upon receiving the provisioning information update from the PPS, the FSN may set a timer to expire before the start time of the flow. When the timer expires, the FSN sends an ActivateFlowRequest message to the MUX. Timelines 900 and 1000 are further described with regard to FIG. 11 as a sequence of events or methodology, below.

FIG. 11 illustrates a methodology 1100 of providing an IP datacast service to a FLO device, in accordance with various aspects. As in real-time and non real-time services, an IP datacast service may be provisioned and planned. For each IP datacast flow, an operator may provision quality-of-service (QoS) parameters at 1102. The QoS parameters may include, without being limited to, average data rate, maximum burst size, peak rate, latency, start times, packet error rate, and duration and the identification of the originator or source of the IP datacast content. The operator may use Service Planner software to determine whether there is sufficient bandwidth to accommodate the IP datacast flow. After the operator has successfully provisioned and planned the IP datacast flows, updated provisioned information may be sent from a Provisioning and Planning Subsystem (PPS) to a Multiplexer (MUX), at 1104. All associated IP datacast flows may be in a deactivated state awaiting activation by an FSN. Additionally, when the operator has successfully provisioned and planned the IP datacast flows, the updated provisioned information for the IP datacast may sent from the PPS to the FSN, at 1108. The FSN may then employ the information to authenticate the source, ask for the FLO resource, and perform admission control and scheduling.

At 1108, the IP datacast source requests a FLO resource by sending an AddFlowRequest message to the FSN. The AddFlowRequest message may comprise information such as the datacast source IP address, port number, QoS parameter values, source ID, and the start time and duration of the data flow. At 1110, the FSN authenticates and performs admission control of the source based on the provisioned policy information. The FSN maps the <IP Address, port number> pair of the datacast source to the flow ID of the source at 1112, and then sends an ActivateFlowRequest message to the MUX with the flow ID and start time. At 1114 The MUX updates the flow description message in a control channel by including the newly activated flow ID. The MUX updates the systems parameter message using Overhead Information Symbols (OIS) to reflect the change in the control channel and the start time of the flow in superframes.

After a successful update of the flow description message in the control channel, the MUX sends an ActivateFlowResponse message to the FSN, at 1116. The FSN returns an acknowledgement to the IP datacast source using an AddFlowResponse message, at 1118, which contains a FlowHandle used to reference the successfully reserved flow. The updated flow description message and systems parameter message are broadcast over the air at 1120. In the event that multicast routing is not available, the IP datacast can utilize IP unicast tunneling by encapsulating multicast IP datagrams within unicast IP headers and addressing the datagrams to the FSN, at 1122.

Additionally or alternatively, the IP datacast can send IP datagrams directly to the multicast address, at 1124. This approach assumes that the multicast routers between the IP datacast source and FSN are multicast-aware. The FSN first sends an IGMP Join message to its hop router to receive routed datagrams for the specified multicast group. The FSN may then receive IP datagrams via IP multicast routing, and can segment the datagrams into FLO frames and add appropriate headers, at 1126. The FSN optionally performs encryption and header compression.

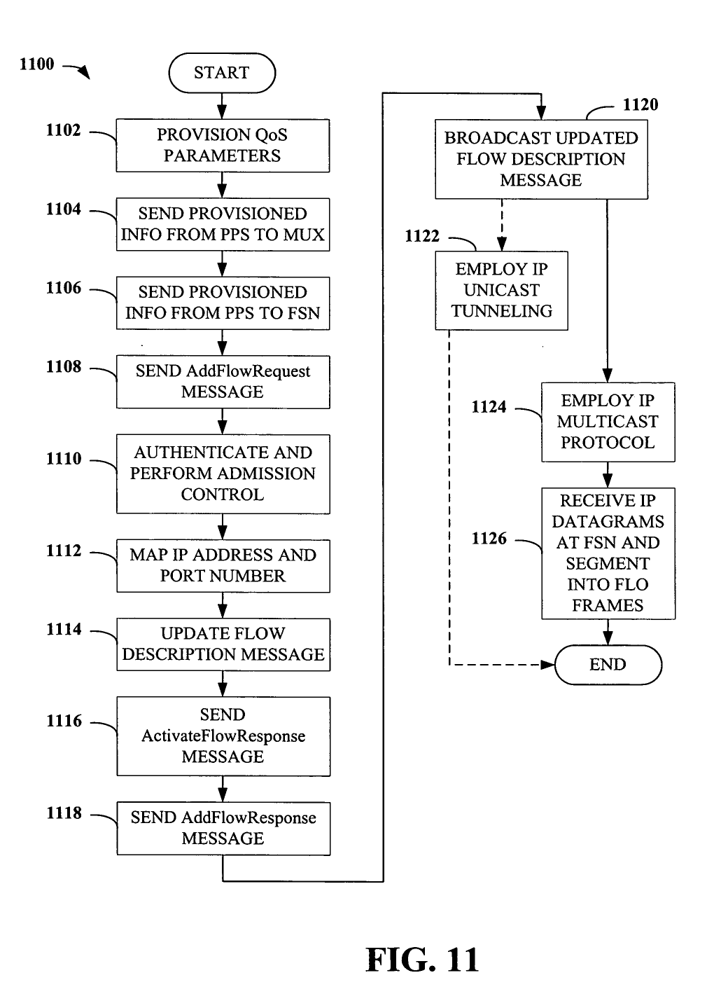

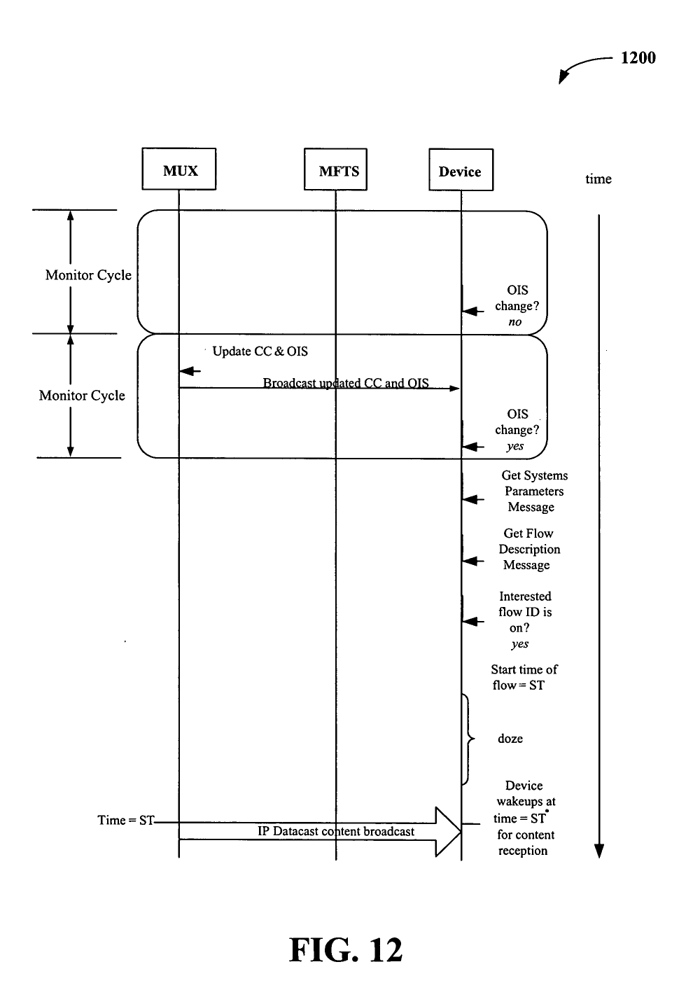

FIG. 12 illustrates a timeline 1200 for receiving IP datacast content at a user device, in accordance with various aspects described herein. Timeline 1200 depicts a call flow for device reception of IP datacast content, which comprises monitoring incoming signals to detect a change in overhead information symbols (OISs), upon which the call flow is initiated. Timeline 1200 is described as a sequence of events, or a methodology, in FIG. 13, below.

FIG. 13 illustrates a methodology 1300 of receiving IP datacast content over a FLO interface at user device, in accordance with several aspects. At 1302, a user device can wake up periodically to monitor an IP data flow (e.g., to determine whether an IP data flow is on), over an open port on an FLO interface. The device wakeup period may be based on a predefined monitor cycle period. If the device detects no change, it may go back to sleep. When a MUX has received an ActivateFlowRequest from an FSN to turn on the flow, the MUX updates a Systems Parameter message in the OIS and the flow description message in the Control Channel (CC). The MUX broadcasts the updated messages in the OIS and CC. If such updates have occurred, the device will detect a change in FLO control signaling, at 1304. For instance, the device may process the latest system parameters message to detect a change in the flow description message. The device then processes the latest flow description message. At 1306.

If the device finds a flow ID in the flow description message, it may note the start time of the flow content, and then sleep, at 1308, until the content starts flowing in order to optimize standby battery time for the device. If the device is interested in more than one IP datacast flow, it may periodically wake up based on the monitor cycle to determine if the flows are on the air. At 1310, just prior to the start time of the content broadcast, the device may wake up to receive the content. At 1312, the device may receive the IP datacast content from a MUX, at start time.

The following discussion is provided to facilitate understanding of the preceding systems and/or methodologies. As described here, “flow ID mapping” relates to a protocol that maps multicast IP address and port number pairs to a flow ID. The mapping function may be stored by both the FSN and the device. After successful reception of an AddFlowRequest message containing an IP multicast address and port number from an IP datacast source, the FSN maps the IP address and port number to a flow ID. The flow ID is used by the FSN to request that a MUX include the flow ID in the flow description message. On the device side, the IP datacast application opens a multicast socket containing the IP multicast address and port number of the FLO air interface. A FLOMCMgr in a Data Stack maps the IP address and port number to the associated flow ID and commands a receiver to tune into the specified flow ID when it is active. The following paragraphs describe examples of flow ID mapping using different IP formats. IP version 4 (IPv4) and version 6 (IPv6) multicast address formats are discussed, and the details of the flow ID mapping function are provided. It will be appreciated by those skilled in the art that the following examples are illustrative in nature, and are not intended to limit the scope of the various aspects described herein.

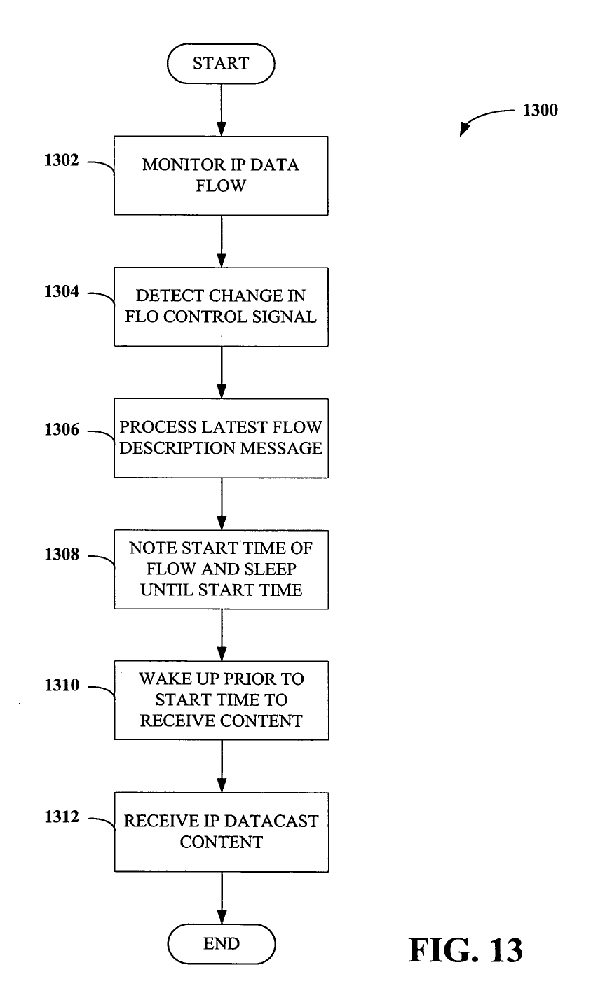

FIG. 14 illustrates an IPv4 multicast address format 1400, in accordance with various aspects. The first 4 bits are used for a class D prefix and are typically 1110 for FLO. The last 28 bits are utilized for group identification. The IPv4 multicast address range may extend from 224.0.0.0 to 239.255.255.255. The Internet Assigned Numbers Authority (IANA) has assigned the address range of 239.192.0.0 to 239.251.255.255 for an organizational-local scope. The FLO system may utilize these IP addresses for flow ID mapping.

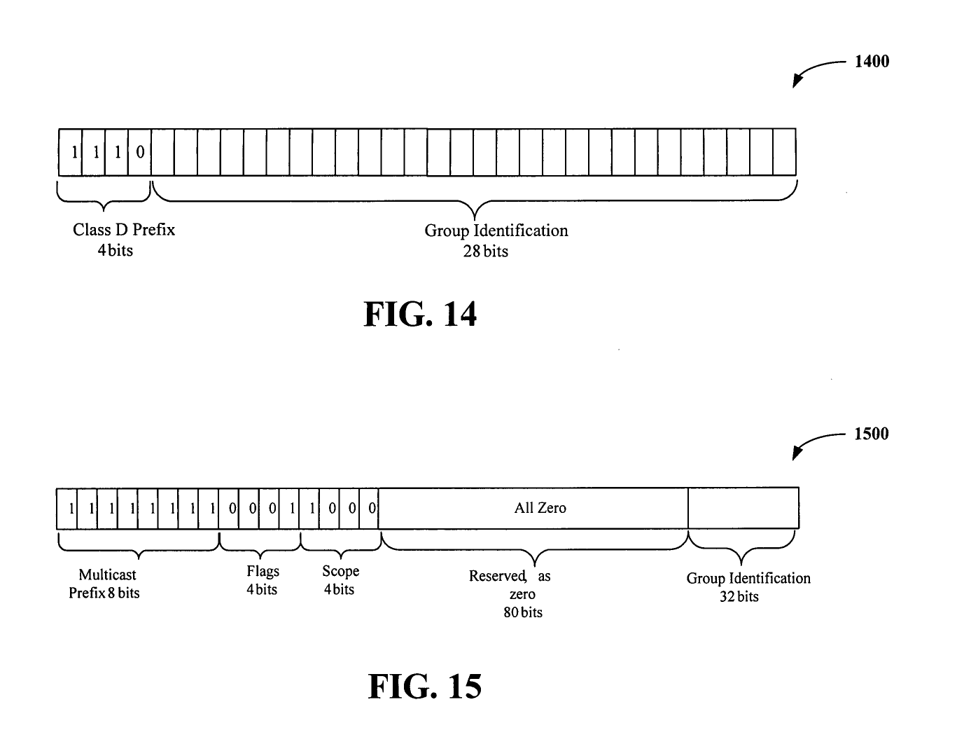

FIG. 15 is an illustration of an IPv6 multicast address format 1500, in accordance with various aspects. The first 8 bits of an IPv6 multicast address are 1111 1111 or 0xFF. The Flag field indicates whether or not a multicast address is permanently assigned. If a non-permanently assigned address is used, the Flag field has the value 0001. If an organization-local scope address is used, the Scope field has the value 1000. This leaves a pool of 2³² other available addresses in the range FF18:0:0:0:0:0:0:0-FF18:0:0:0:0:0:FFFF:FFFF. The IANA has assigned the address range of FF18::00 to FF18::FFFF:FFFF to the organizational scope. The FLO system may make use of IP multicast addresses defined for organizational-local scope for flow ID mapping.

The port numbers mapped to the flow ID may be divided into three ranges: well-known ports, registered ports, and dynamic and/or private ports. Well-known ports are numbered from 0 through 1023, are assigned by IANA, and typically can only be used by systems or root processes or by programs executed by privileged users. For example, port 21 is the well-known port number for ftp sites using Transfer Control Protocol (TCP) for file transfer. Registered ports are numbered from 1024 through 49151 and are registered by companies and other users with the Internet Corporation for Assigned Names and Numbers (ICANN) for use by the application that communicates using the Internet's TCP and User Datagram Protocol (UDP). Private ports are numbered from 49152 through 65535 and are available for use by applications communicating with one another via TCP or UDP.

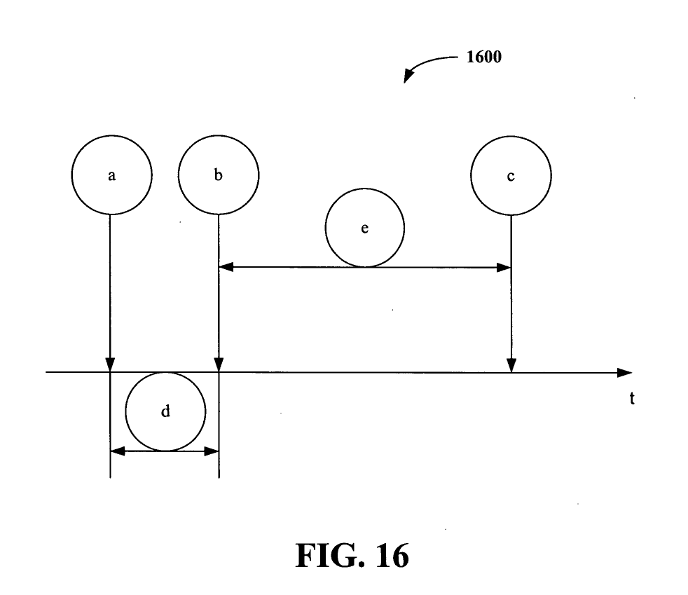

FIG. 16 illustrates a timeline 1600 for activating and transmitting an IP datacast flow, in accordance with various aspects. At time (a), an FSN may receive thane AddFlowRequest message from an IP datacast source. At time (b), the FSN may send a message to a MUX to activate an IP datacast flow. Time (c) represents the start of the IP datacast flow. Period (d), between times (a) and (b), corresponds to an “AddFlow” timer, T_{addFlow}, which is a delay on the FSN to process the AddFlowRequest message and send an ActivateFlowRequest message to the MUX. Period (e), between times (b) and (c), corresponds to an Activation Timer, T_{IPDCFlowActivation}, which is a time interval during which the IP datacast flow may be activated before the content start time, at which the content of the IP datacast flow is broadcast over the air. The AddFlowRequest message may arrive at the FSN before the flow is activated, at the time in seconds specified by the T_{AddFlow} parameter. The flow may be activated before the IP datacast flow is broadcast, which is defined as the start time of the IP datacast flow, which is specified in seconds by the T_{IPDCFlowActivation} parameter.

Different devices have different wakeup times that are based on the first time the device gets a System Parameters message in the OIS. To ensure that all devices of interest are notified that the flow is active before content is broadcast, the flow description message may be advertised before the content is broadcast, for instance, at least one monitor cycle period seconds before the flow will be active. The time specified for the T_{IPDCFIowActivation} parameter may therefore be greater than the monitor cycle period. If the AddFlow interface is not implemented, the FSN may still activate the flow before the start time of the IP datacast flow by at least the time specified in seconds by the T_{IPDCFlowActivation} parameter.

The FSN will indicate the start time in the ActivateFlowRequest message in absolute time in Coordinated Universal Time (UTC). The MUX converts the start time into the number of superframes from the superframe in which it first added the flow ID into the flow description message. The MUX then sets the NxtSuperfrmOffset parameter in the system parameters message to the start time as represented in superframes. The value of the NxtSuperfrmOffset parameter may be utilized to specify the start time at which the FLO Logical Channel (MLC) associated with the IP datacast flow begins broadcasting. If no other socket is open on the FLO air interface, the device may sleep until approximately one superframe before the start time, when it wakes up to receive content. As used herein, the term socket is employed loosely to represent any application, including IP datacast or the FLO client application that is interested in getting content over the FLO air interface.

The FSN utilizes the De-ActivateFlowRequest interface to terminate one or more IP datacast flows. After the successful processing of a deactivate flow request message, the MUX removes the flow description message corresponding to the flow ID that has been deactivated. The MUX also stops processing any data from the IP datacast flow with the deactivated flow ID.

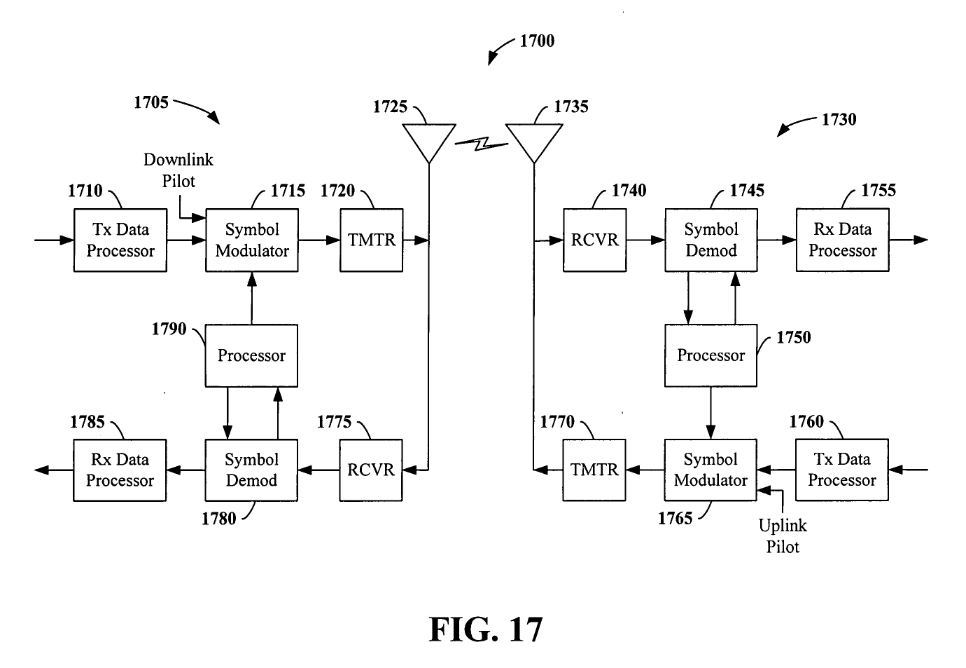

FIG. 17 shows an exemplary wireless communication system 1700. The wireless communication system 1700 depicts one base station and one terminal for sake of brevity. However, it is to be appreciated that the system can include more than one base station and/or more than one terminal, wherein additional base stations and/or terminals can be substantially similar or different for the exemplary base station and terminal described below. In addition, it is to be appreciated that the base station and/or the terminal can employ the systems (FIGS. 1, 3-10, 12, 14-16, and 18-21) and/or methods (FIGS. 2, 11, and 13) described herein to facilitate wireless communication there between.

Referring now to FIG. 17, on a downlink, at access point 1705, a transmit (TX) data processor 1710 receives, formats, codes, interleaves, and modulates (or symbol maps) traffic data and provides modulation symbols (“data symbols”). A symbol modulator 1715 receives and processes the data symbols and pilot symbols and provides a stream of symbols. A symbol modulator 1720 multiplexes data and pilot symbols and provides them to a transmitter unit (TMTR) 1720. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 1720 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1725 to the terminals. At terminal 1730, an antenna 1735 receives the downlink signal and provides a received signal to a receiver unit (RCVR) 1740. Receiver unit 1740 conditions (e.g., filters, amplifies, and frequency downconverts) the received signal and digitizes the conditioned signal to obtain samples. A symbol demodulator 1745 demodulates and provides received pilot symbols to a processor 1750 for channel estimation. Symbol demodulator 1745 further receives a frequency response estimate for the downlink from processor 1750, performs data demodulation on the received data symbols to obtain data symbol estimates (which are estimates of the transmitted data symbols), and provides the data symbol estimates to an RX data processor 1755, which demodulates (i.e., symbol demaps), deinterleaves, and decodes the data symbol estimates to recover the transmitted traffic data. The processing by symbol demodulator 1745 and RX data processor 1755 is complementary to the processing by symbol modulator 1715 and TX data processor 1710, respectively, at access point 1705.

On the uplink, a TX data processor 1760 processes traffic data and provides data symbols. A symbol modulator 1765 receives and multiplexes the data symbols with pilot symbols, performs modulation, and provides a stream of symbols. A transmitter unit 1770 then receives and processes the stream of symbols to generate an uplink signal, which is transmitted by the antenna 1735 to the access point 1705.

At access point 1705, the uplink signal from terminal 1730 is received by the antenna 1725 and processed by a receiver unit 1775 to obtain samples. A symbol demodulator 1780 then processes the samples and provides received pilot symbols and data symbol estimates for the uplink. An RX data processor 1785 processes the data symbol estimates to recover the traffic data transmitted by terminal 1730. A processor 1790 performs channel estimation for each active terminal transmitting on the uplink. Multiple terminals may transmit pilot concurrently on the uplink on their respective assigned sets of pilot subbands, where the pilot subband sets may be interlaced.

Processors 1790 and 1750 direct (e.g., control, coordinate, manage, etc.) operation at access point 1705 and terminal 1730, respectively. Respective processors 1790 and 1750 can be associated with memory units (not shown) that store program codes and data. Processors 1790 and 1750 can also perform computations to derive frequency and impulse response estimates for the uplink and downlink, respectively.

For a multiple-access system (e.g., FDMA, OFDMA, CDMA, TDMA, etc.), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 1790 and 1750.

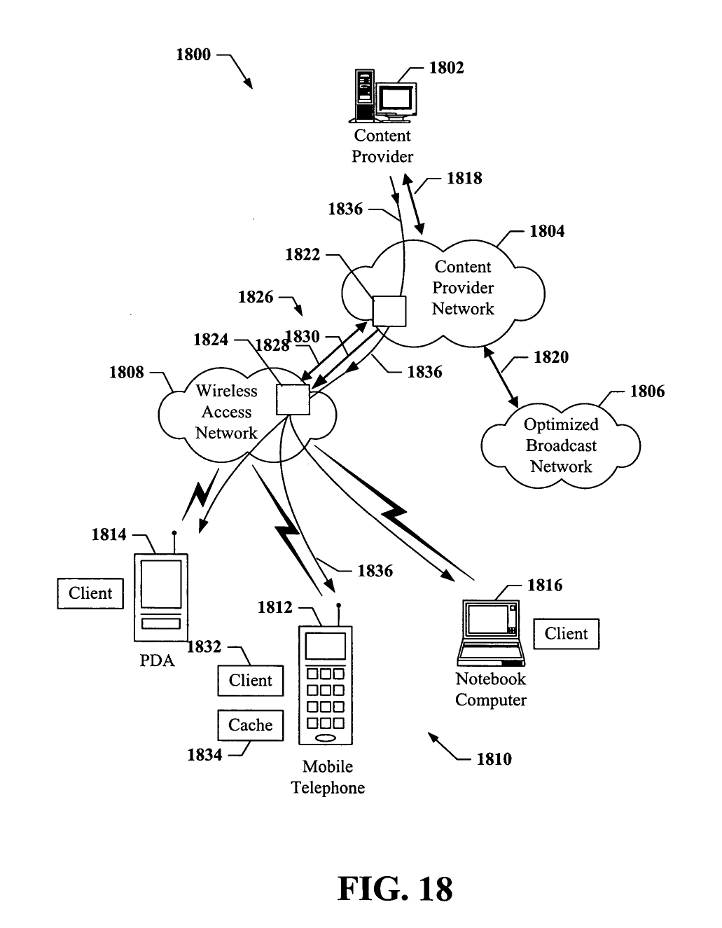

FIG. 18 illustrates a communication network 1800 that comprises a transport system that operates to create and transport multimedia content flows across data networks, in accordance with various aspects. For example, the transport system is suitable for use in transporting content clips from a content provider network to a wireless access network for broadcast distribution. The network 1800 comprises a content provider (CP) 1802, a content provider network 1804, an optimized broadcast network 1806, and a wireless access network 1808. The network 1800 also includes devices 1810 that comprise a mobile telephone 1812, a personal digital assistance (PDA) 1814, and a notebook computer 1816. The devices 1810 illustrate just some of the devices that are suitable for use in one or more aspects of the transport system. It should be noted that although three devices are shown in FIG. 18, virtually any number of devices, or types of devices are suitable for use in the transport system.

The content provider 1802 operates to provide content for distribution to users in the network 1800. The content comprises video, audio, multimedia content, clips, real-time and non real-time content, scripts, programs, data or any other type of suitable content. The content provider 1802 provides the content to the content provider network 1804 for distribution. For example the content provider 1802 communicates with the content provider network 1804 via the communication link 1818, which comprises any suitable type of wired and/or wireless communication link.

The content provider network 1804 comprises any combination of wired and wireless networks that operate to distribute content for delivery to users. The content provider network 1804 communicates with the optimized broadcast network 1806 via the link 1820. The link 1820 comprises any suitable type of wired and/or wireless communication link. The optimized broadcast network 1806 comprises any combination of wired and wireless networks that are designed to broadcast high quality content. For example, the optimized broadcast network 1806 may be a specialized proprietary network that has been optimized to deliver high quality content to selected devices over a plurality of optimized communication channels.

In one or more aspects, the transport system operates to deliver content from the content provider 1802 for distribution to a content server (CS) 1822 at the content provider network 1804 that operates to communicate with a broadcast base station (BBS) 1824 at the wireless access network. The CS 1822 and the BBS 1824 communicate using one or more aspects of a transport interface 1826 that allows the content provider network 1804 to deliver content in the form of content flows to the wireless access network 1808 for broadcast/multicast to the devices 1810. The transport interface 1826 comprises a control interface 1828 and a bearer channel 1830. The control interface 1828 operates to allow the CS 1822 to add, change, cancel, or otherwise modify contents flows that flow from the content provider network 1804 to the wireless access network 1808. The bearer channel 1830 operates to transport the content flows from the content provider network 1804 to the wireless access network 1808.

According to some aspects, the CS 1822 uses the transport interface 1826 to schedule a content flow to be transmitted to the BBS 1824 for broadcast/multicast over the wireless access network 1808. For example, the content flow may comprise a non real-time content clip that was provided by the content provider 1802 for distribution using the content provider network 1804. In one aspect, the CS 1822 operates to negotiate with the BBS 1824 to determine one or more parameters associated with the content clip. Once the BBS 1824 receives the content clip, it broadcasts/multicasts the content clip over the wireless access network 1808 for reception by one or more of the devices 1810. Any of the devices 1810 may be authorized to receive the content clip and cache it for later viewing by the device user.

For example, the device 1810 comprises a client program 1832 that operates to provide a program guide that displays a listing of content that is scheduled for broadcast over the wireless access network 1808. The device user may then select to receive any particular content for rendering in real-time or to be stored in a cache 1834 for later viewing. For example the content clip may be scheduled for broadcast during the evening hours, and the device 1812 operates to receive the broadcast and cache the content clip in the cache 1834 so that the device user may view the clip the next day. Typically, the content is broadcast as part of a subscription service and the receiving device may need to provide a key or otherwise authenticate itself to receive the broadcast. In one or more aspects, the transport system allows the CS 1822 to receive program-guide records, program contents, and other related information from content provider 1802. The CS 1822 updates and/or creates content for delivery to devices 1810.

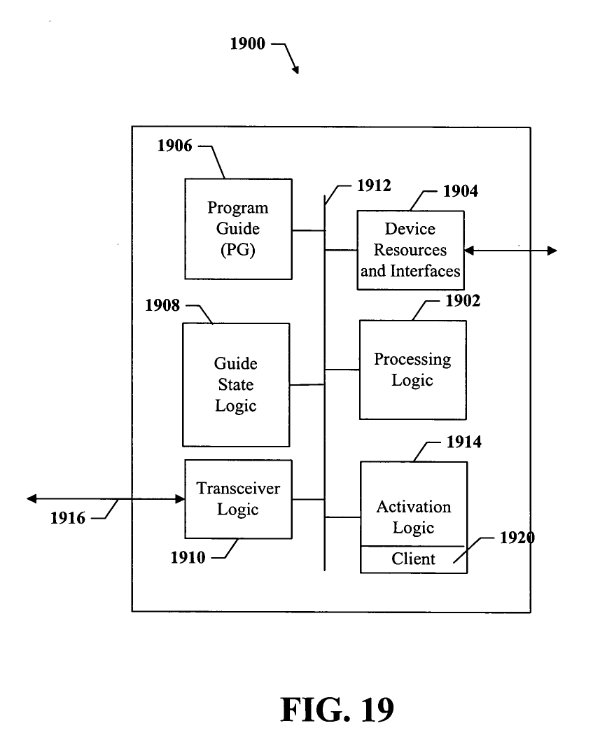

FIG. 19 illustrates various aspects of a content provider server 1900 suitable for use in a content delivery system. For example, the server 1900 may be used as the server 1902 in FIG. 19. The server 1900 comprises processing logic 1902, resources and interfaces 1904, and transceiver logic 1910, all coupled to an internal data bus 1912. The server 1900 also comprises activation logic 1914, PG 1906, and PG records logic 1908, which are also coupled to the data bus 1912. In one or more aspects, the processing logic 1902 comprises a CPU, processor, gate array, hardware logic, memory elements, virtual machine, software, and/or any combination of hardware and software. Thus, the processing logic 1902 generally comprises logic to execute machine-readable instructions and to control one or more other functional elements of the server 1900 via the internal data bus 1912.

The resources and interfaces 1904 comprise hardware and/or software that allow the server 1900 to communicate with internal and external systems. For example, the internal systems may include mass storage systems, memory, display driver, modem, or other internal device resources. The external systems may include user interface devices, printers, disk drives, or other local devices or systems. The transceiver logic 1910 comprises hardware logic and/or software that operates to allow the server 1900 to transmit and receive data and/or other information with remote devices or systems using communication channel 1916. For example, in one aspect, the communication channel 1916 comprises any suitable type of communication link to allow the server 1900 to communicate with a data network.

The activation logic 1914 comprises a CPU, processor, gate array, hardware logic, memory elements, virtual machine, software, and/or any combination of hardware and software. The activation logic 1914 operates to activate a CS and/or a device to allow the CS and/or the device to select and receive content and/or services described in the PG 1906. In one aspect, the activation logic 1914 transmits a client program 1920 to the CS and/or the device during the activation process. The client program 1920 runs on the CS and/or the device to receive the PG 1906 and display information about available content or services to the device user. Thus, the activation logic 1914 operates to authenticate a CS and/or a device, download the client 1920, and download the PG 1906 for rendering on the device by the client 1920.

The PG 1906 comprises information in any suitable format that describes content and/or services that are available for devices to receive. For example, the PG 1906 may be stored in a local memory of the server 1900 and may comprise information such as content or service identifiers, scheduling information, pricing, and/or any other type of relevant information. In one aspect, the PG 1906 comprises one or more identifiable sections that are updated by the processing logic 1902 as changes are made to the available content or services.

The PG record 1908 comprises hardware and/or software that operates to generate notification messages that identify and/or describe changes to the PG 1906. For example, when the processing logic 1902 updates the PG 1906, the PG records logic 1908 is notified about the changes. The PG records logic 1908 then generates one or more notification messages that are transmitted to CSs, which may have been activated with the server 1900, so that these CSs are promptly notified about the changes to the PG 1906.

In various aspects, as part of the content delivery notification message, a broadcast indicator is provided that indicates when a section of the PG identified in the message will be broadcast. For example, in one aspect, the broadcast indicator comprises one bit to indicate that the section will be broadcast and a time indicator that indicates when the broadcast will occur. Thus, the CSs and/or the devices wishing to update their local copy of the PG records can listen for the broadcast at the designated time to receive the updated section of the PG records. In one aspect, the content delivery notification system comprises program instructions stored on a computer-readable media, which when executed by a processor, for instance, the processing logic 1902, provides the functions of the server 1900 described herein. For example, the program instructions may be loaded into the server 1900 from a computer-readable media, such as a floppy disk, CDROM, memory card, FLASH memory device, RAM, ROM, or any other type of memory device or computer-readable media that interfaces to the server 1900 through the resources 1904. In another aspect, the instructions may be downloaded into the server 1900 from an external device or network resource that interfaces to the server 1900 through the transceiver logic 1910. The program instructions, when executed by the processing logic 1902, provide one or more aspects of a guide state notification system as described herein.

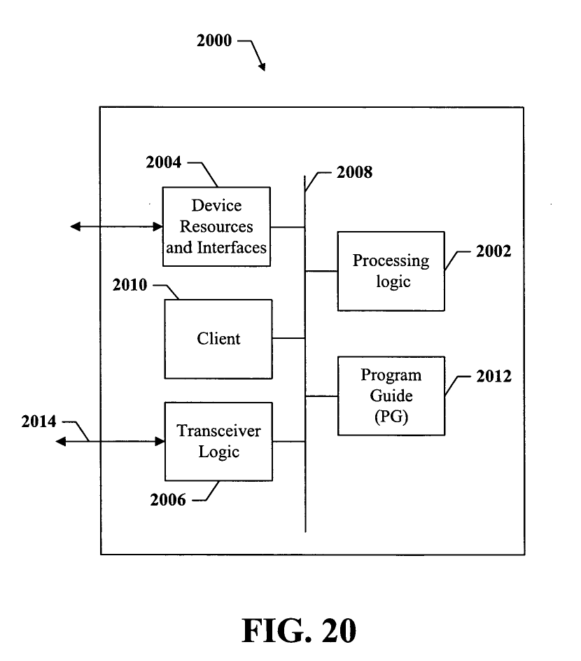

FIG. 20 illustrates a content server (CS) or device 2000 suitable for use in a content delivery system, in accordance with one or more aspects. For example, CS 2000 may be the CS 1922 or the device 1910 shown in FIG. 19. The CS 2000 comprises processing logic 2002, resources and interfaces 2004, and transceiver logic 2006, all coupled to a data bus 2008. The CS 2000 also comprises a client 2010, a program logic 2014 and a PG logic 2012, which are also coupled to the data bus 2008. In one or more aspects, the processing logic 2002 comprises a CPU, processor, gate array, hardware logic, memory elements, virtual machine, software, and/or any combination of hardware and software. Thus, the processing logic 2002 generally comprises logic configured to execute machine-readable instructions and to control one or more other functional elements of the CS 2000 via the internal data bus 2008.

The resources and interfaces 2004 comprise hardware and/or software that allow the CS 2000 to communicate with internal and external systems. For example, internal systems may include mass storage systems, memory, display driver, modem, or other internal device resources. The external systems may include user interface devices, printers, disk drives, or other local devices or systems. The transceiver logic 2006 comprises hardware and/or software that operate to allow the CS 2000 to transmit and receive data and/or other information with external devices or systems through communication channel 2014. For example the communication channel 2014 may comprise a network communication link, a wireless communication link, or any other type of communication link.

During operation, the CS and/or the device 2000 is activated so that it may receive available content or services over a data network. For example, in one aspect, the CS and/or the device 2000 identifies itself to a content provider server during an activation process. As part of the activation process, the CS and/or the device 2000 receives and stores PG records by PG logic 2012. The PG 2012 contains information that identifies content or services available for the CS 2000 to receive. The client 2010 operates to render information in the PG logic 2012 on the CS and/or the device 2000 using the resources and interfaces 2004. For example, the client 2010 renders information in the PG logic 2012 on a display screen that is part of the device. The client 2010 also receives user input through the resources and interfaces so that a device user may select content or services.

In some aspects, the CS 2000 receives notification messages through the transceiver logic 2006. For example, the messages may be broadcast or unicast to the CS 2000 and received by the transceiver logic 2006. The PG notification messages identify updates to the PG records at the PG logic 2012. In one aspect, the client 2010 processes the PG notification messages to determine whether the local copy at the PG logic 2012 needs to be updated. For example, in one aspect, the notification messages include a section identifier, start time, end time, and version number. The CS 2000 operates to compare the information in the PG notification messages to locally stored information at the existing PG logic 2012. If the CS 2000 determines from the PG notification messages that one or more sections of the local copy at the PG logic 2012 needs to be updated, the CS 2000 operates to receive the updated sections of the PG in one of several ways. For example, the updated sections of the PG may be broadcasted at a time indicated in the PG notification messages, so that the transceiver logic 2006 may receive the broadcasts and pass the updated sections to the CS 2000, which in turn updates the local copy at the PG logic 2012.

In other aspects, the CS 2000 determines which sections of the PG need to be updated based on the received PG update notification messages, and transmits a request to a CP server to obtain the desired updated sections of the PG. For example, the request may be formatted using any suitable format and comprise information such as a requesting CS identifier, section identifier, version number, and/or any other suitable information. In one aspect, the CS 2000 performs one or more of the following functions in one or more aspects of a PG notification system. It should be noted that the following functions might be changed, rearranged, modified, added to, deleted, or otherwise adjusted within the scope of the aspects. The CS may be activated for operation with a content provider system to receive content or services. As part of the activation process, a client and PG are transmitted to the CS. One or more PG notification messages may be received by the CS and used to determine if one or more sections of the locally stored PG need to be updated. In one aspect, if the CS determines that one or more sections of the locally stored PG need to be updated, the CS listens to a broadcast from the distribution system to obtain the updated sections of the PG that it needs to update its local copy. In another aspect, the CS transmits one or more request messages to the CP to obtain the updated sections of the PG it needs. In response to the request, the CP transmits the updated sections of the PG to the CS. The CS uses the received updated sections of the PG to update its local copy of the PG.

According to still other aspects, the content delivery system comprises program instructions stored on a computer-readable media, which when executed by a processor, such as the processing logic 2002, provides the functions of the content delivery notification system as described herein. For example, instructions may be loaded into the CS 2000 from a computer-readable media, such as a floppy disk, CDROM, memory card, FLASH memory device, RAM, ROM, or any other type of memory device or computer-readable media that interfaces to the CS 2000 through the resources and interfaces 2004. In another aspect, the instructions may be downloaded into the CS 2000 from a network resource that interfaces to the CS 2000 through the transceiver logic 2006. The instructions, when executed by the processing logic 2002, provide one or more aspects of a content delivery system as described herein. It should be noted that the CS 2000 represents just one implementation and that other implementations are possible within the scope of the aspects.

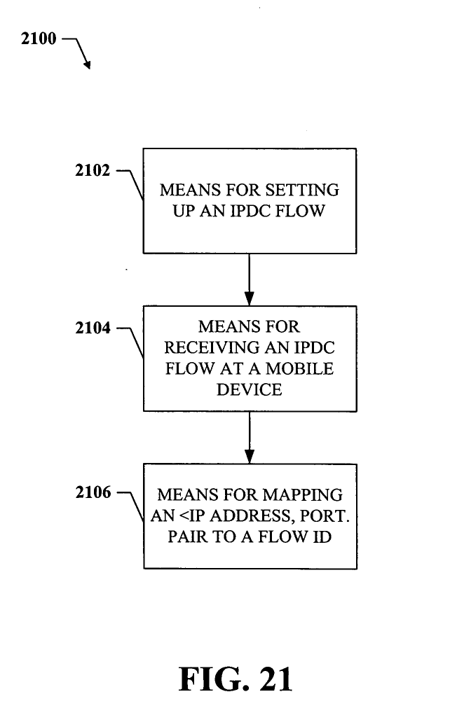

FIG. 21 is an illustration of an apparatus 2100 that facilitates performing IP datacasts over a FLO interface, in accordance with various aspects presented herein. The apparatus 2100 comprises means for setting up an IPDC flow, as is described above with regard to the preceding figures. The apparatus 2100 further comprises means for receiving the IPDC flow at a user device. Still further, the apparatus 2100 comprises means for mapping an IP address and port information to a flow ID for the IPDC flow in order to facilitate transporting IP datagrams over a broadcast wireless network. In this manner, apparatus 2100 allows a third-party 1P applications to be operated over the FLO network without having to understand FLO-specific lower layer protocols. The IP datacast feature can provide a wireless IP multicast service that allows the FLO, or a third-party operator to multicast content using an Internet Engineering Task Force (IETF) protocol, over the FLO network. The FLO network can additionally provide a range of quality-of-service (QoS) benefits for delivering IP multicast datagrams.

According to an example, the IP datacast may be offered as a FLO service, or may be offered by a third-party service provider, in which case the FLO network may be used as a data pipe. If the FLO network is used as a data pipe, a third-party service provider may offer IP datacast services. The services need not be listed as FLO subscription packages, and subscription and key management may be performed externally to the FLO network. A third-party service provider may request the FLO network as a data transmission pipe, and data payload may pass through the network without modification.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of transporting Internet protocol datacasts (IPDCs) over a forward-link-only (FLO) network in a wireless communication environment, comprising:
setting up an IPDC flow;
receiving the IPDC flow at a user device; and
mapping a IP address and port data pair to a flow ID for the IPDC flow.

2. The method of claim 1, wherein setting up the IPDC flow further comprises analyzing quality of service (QoS) parameter information.

3. The method of claim 2, wherein the QoS parameters comprise at least one of average data rate, maximum burst size, peak rate, latency, start times, packet error rate, and duration and identification of an originator or source of the IP datacast content.

4. The method of claim 1, further comprising requesting a FLO resource.

5. The method of claim 1, further comprising transmitting a request to activate a flow comprising a flow ID and start time.

6. The method of claim 5, further comprising updating a flow description message in a control channel to include a newly activated flow ID.

7. The method of claim 6, further comprising receiving a response that the flow has been activated.

8. The method of claim 7, further comprising transmitting a response to acknowledge that the flow has been reserved, wherein the response comprises a flow handle that is employed to reference the reserved flow.

9. The method of claim 8, further comprising receiving a broadcast datagram and segmenting the datagram into FLO frames with appropriate headers.

10. An apparatus that facilitates transmitting IP datagrams in a FLO network in a wireless communication environment, comprising:
a receiver that receives an IPDC flow; and
a processor that maps a IP address and port data pair to a flow ID for the IPDC flow.

11. The apparatus of claim 10, wherein the processor analyzes quality of service (QoS) parameter information.

12. The apparatus of claim 2, wherein the QoS parameter information comprises at least one of average data rate, maximum burst size, peak rate, latency, start times, packet error rate, and duration and identification of an originator or source of the IP datacast content.

13. The apparatus of claim 10, further comprising a transmitter that transmits a request to activate a flow comprising a flow ID and start time.

14. The apparatus of claim 13, wherein the processor updates a flow description message in a control channel to include a newly activated flow ID.

15. The apparatus of claim 14, wherein the receiver receives a response that the flow has been activated.

16. The apparatus of claim 15, wherein the transmitter an acknowledgment that the flow has been reserved, the acknowledgment comprising a flow handle that is employed to reference the reserved flow.

17. The apparatus of claim 16, wherein the receiver receives a broadcast datagram and the processor segments the datagram into FLO frames with appropriate headers.

18. A wireless communication apparatus, comprising:
means for setting up an IPDC flow;
means for receiving the IPDC flow; and
means for mapping a IP address-and-port data pair to a flow ID for the IPDC flow.

19. The apparatus of claim 18, further comprising means for analyzing quality of service (QoS) parameter information.

20. The apparatus of claim 19, wherein the QoS parameters comprise at least one of average data rate, maximum burst size, peak rate, latency, start times, packet error rate, and duration and identification of an originator or source of the IP datacast content.

21. The apparatus of claim 18, further comprising means for requesting a FLO resource.

22. The apparatus of claim 18, further comprising means for transmitting a request to activate a flow, the request comprising a flow ID and start time.

23. The apparatus of claim 22, further comprising means for updating a flow description message in a control channel to include a newly activated flow ID.

24. The apparatus of claim 23, wherein the means for receiving receives a response that the flow has been activated.

25. The apparatus of claim 24, wherein the means for transmitting sends a response to acknowledge that the flow has been reserved, the response comprising a flow handle that is employed to reference the reserved flow.

26. The apparatus of claim 25, wherein the means for receiving receives a broadcast datagram and segmenting the datagram into FLO frames with appropriate headers.

27. A computer-readable medium having a computer program comprising computer-executable instructions for:
generating an IPDC flow;
receiving the IPDC flow at a user device; and
mapping a IP address and port data pair to a flow ID for the IPDC flow.

28. The computer-readable medium of claim 27, further comprising instructions for analyzing quality of service (QoS) parameter information, wherein the QoS parameters comprise at least one of average data rate, maximum burst size, peak rate, latency, start times, packet error rate, and duration and identification of an originator or source of the IP datacast content.

29. The computer-readable medium of claim 27, further comprising instructions for requesting a FLO resource.

30. The computer-readable medium of claim 27, further comprising instructions for transmitting a request to activate a flow comprising a flow ID and start time and for updating a flow description message in a control channel to include a newly activated flow ID.

31. The computer-readable medium of claim 30, further comprising instructions for receiving a response that the flow has been activated, and for transmitting a response to acknowledge that the flow has been reserved, wherein the response comprises a flow handle that is employed to reference the reserved flow.

32. The computer-readable medium of claim 31, further comprising instructions for receiving a broadcast datagram and segmenting the datagram into FLO frames with appropriate headers.

33. A processor that executes instructions for increasing throughput in a wireless communication environment, the instructions comprising:
setting up an IPDC flow;
receiving the IPDC flow at a user device; and
mapping a IP address and port data pair to a flow ID for the IPDC flow.

34. The processor of claim 33, the instructions further comprising requesting a FLO resource.

35. The processor of claim 34, the instructions further comprising transmitting a request to activate a flow comprising a flow ID and start time.

36. The processor of claim 35, the instructions further comprising updating a flow description message in a control channel to include a newly activated flow ID and receiving a response that the flow has been activated.

37. The method of claim 36, the instructions further comprising transmitting a response to acknowledge that the flow has been reserved, wherein the response comprises a flow handle that is employed to reference the reserved flow.

38. The method of claim 37, the instructions further comprising receiving a broadcast datagram and segmenting the datagram into FLO frames with appropriate headers.
